(19) United States
(12) Patent Application Publication
(10) Pub. No.: US 2006/0121887 A1
(43) Pub. Date: Jun. 8, 2006

(54) Message priority mechanism

(76) Inventor: Muralidharan S. Chilukoor, Bangalore (IN)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/009,286

(22) Filed: Dec. 8, 2004

(51) Int. Cl. H04Q 7/22

(52) U.S. Cl. 455/412.2

(57) ABSTRACT

Method, apparatus and system embodiments are disclosed for a mechanism for permitting a remote message originator to override a silent mode of a wireless communication device. A remote originator of a call or message to the wireless communication device may enter a key value. If the key value and the originator's identity are authenticated, the silent mode is overridden in that a priority message notification, such as an audible tone, is generated. Other embodiments are also described and claimed.

### BACKGROUND

1. Technical Field

The present disclosure relates generally to information processing systems and, more specifically, to a priority mechanism for an incoming message in a wireless system.

2. Background Art

Wireless communication devices may receive incoming messages over a wireless network. The incoming messages may be telephone calls, text messages, voicemail messages, email messages, and the like. The wireless communication device may support various means for indicating to a user that an incoming message is awaiting attention, for identifying the origin of the incoming message, and/or for identifying a priority for the incoming message.

For example, a caller identification (“caller id) feature may be utilized to indicate the origin of an incoming phone call. Also, for example, a caller may associate a text message (such as, for example, “911”) with an incoming message to indicate to the user a priority associated with the incoming message.

A user of a wireless device may elect certain specialized notification means for selected callers or groups of callers. A cell phone or pager may support any of several types of notification modes, including a silent or vibrate mode as well as specialized ring tones. A user may select, for example, that all incoming messages be blocked from ringing or beeping (referred to as a silent mode) when the user is in a situation (business meeting, movie theater, trying to sleep, etc.) for which an audible notification might be disruptive. Alternatively, the user may specify a particular ring or beep pattern to be associated with messages originating from a particular caller or group of callers. If the user does not answer an incoming message, a messaging service provider may provide a voicemail service or text bank service.

### BRIEF DESCRIPTION OF THE DRAWINGS

Embodiments of the present invention may be understood with reference to the following drawings in which like elements are indicated by like numbers. These drawings are not intended to be limiting but are instead provided to illustrate selected embodiments of an apparatus, system, and method for a call priority mechanism. In the drawings:

FIG. 1 is a flowchart illustrating at least one embodiment of a method for a message priority scheme having a caller-override feature.

FIG. 2 is a flowchart illustrating at least one embodiment of method for processing a high priority message.

FIG. 3 is a block diagram illustrating at least one embodiment of a priority module to provide caller override functionality.

FIG. 4 is a block diagram illustrating at least one embodiment of a computing system capable of performing disclosed embodiments of a message priority scheme.

FIG. 5 is a data flow diagram illustrating at least one embodiment of a method for initializing a device into a special silent mode with override feature.

### DETAILED DESCRIPTION

Method, apparatus, and system embodiments disclosed herein disclose a mechanism for indicating message priority for an incoming message in a wireless system. The mechanism provides a caller-override feature. In the following description, numerous specific details such as types of computing devices, message protocols, and system architectures have been set forth to provide a more thorough understanding of the present invention. It will be appreciated, however, by one skilled in the art that embodiments of the invention may be practiced without such specific details. Additionally, some well-known structures, circuits, and the like have not been shown in detail to avoid unnecessarily obscuring the present invention.

In the following discussion, references to “one embodiment”, “an embodiment”, “example embodiment”, “various embodiments”, etc., indicate that the embodiment(s) of the invention so described may include a particular feature, structure, or characteristic, but not every embodiment necessarily includes the particular feature, structure, or characteristic. Further, repeated use of the phrase “in one embodiment” does not necessarily refer to the same embodiment, although it may.

Various embodiments of the invention discussed herein provide for a mechanism to allow a user to indicate priority of incoming messages on a wireless device, where one or more selected callers (referred to generically herein as “originators” to capture all message types) may override the user's selection. A special silent mode may be supported, such that all incoming messages ordinarily are indicated only via a silent notification, such as a blinking light or vibration, or are not indicated at all. A user of a wireless device may designate a selected class of remote entities, referred to as message “originators” (persons or entities placing phone calls, generating email messages, generating text messages, or the like from a device remote from the user's device) to whom are given override rights. The user may set a secret key value to be stored in memory on his wireless device, and may distribute the key value to the originators of the designated class. The user's device may be placed into a special silent mode when the user is attending a meeting, is in a movie theater, is trying to sleep, or otherwise does not wish to be disturbed by an audible message notification. However, a remote entity in the designated class may override the special silent mode by entering the secret key when placing a message to the user. The override may result in an audible indication (or other indication, such as blinking light or vibration) of the message, when such indication would not otherwise be performed for non-priority messages for the given mode.

In this manner, a caller-override feature is provided such that a remote entity may override the special silent mode setting of the user's wireless communication device, and may cause the user's wireless communication device to issue an audible message notification. For a special silent mode that implements an inaudible indicator, such blinking light or vibration, for regular-priority messages, the override message indicator may be an audible indication such as a buzz or ring tone. For other embodiments, the override message indicator may be inaudible, such as a blinking light on the user's communication device, vibration of the user's communication device, backlighting of an alphanumeric message on the user's communication device, transmission of a message or icon to a user's PC or laptop from the user's communication device, or the like.

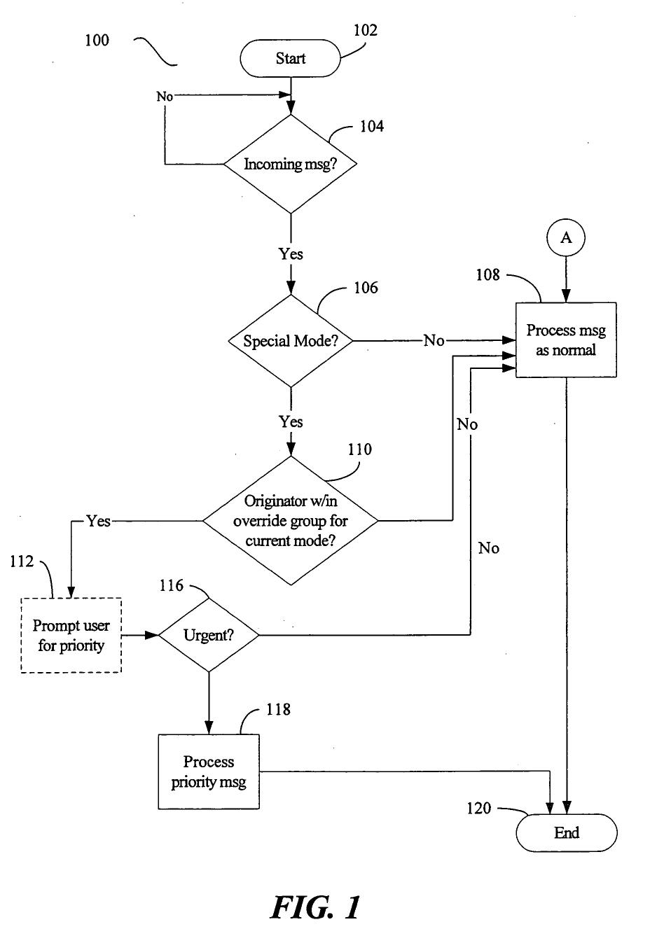

FIG. 1 is a flowchart illustrating at least one embodiment of a method 100 for providing a special silent message mode with caller-override. The method 100 may be implemented, for example, in a wireless communication device such as a cellular telephone, a PCS (personal communications service) system, pager, a third generation (3G) mobile device, BLACKBERRY wireless device, BLUETOOTH device, walkie-talkie or other radio system, etc.

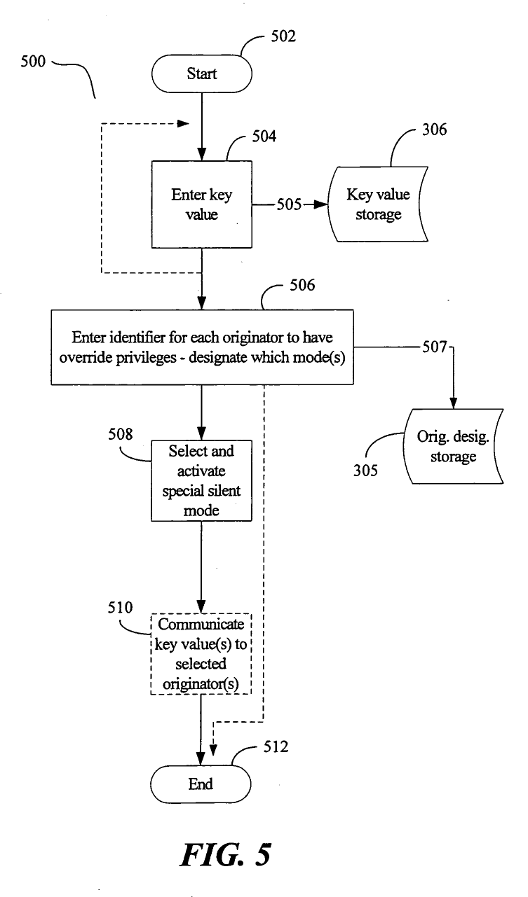

For at least one embodiment of the method 100 illustrated in FIG. 1, it is assumed that the wireless communication device may have previously been placed into a special silent mode. For an example of at least one embodiment of this and other actions that may be taken during an initialization process, please see the description, below, of FIG. 5.

FIG. 1 illustrates that the method begins at block 102 and proceeds to block 104. At block 104, it is determined whether an incoming message is indicated. Such indication may occur, for example, when a service provider indicates to the wireless device that an incoming telephone call, email message, voicemail message, text message, or the like has been received. If it is determined at block 104 that an incoming message is not indicated, then processing loops back to block 102.

One of skill in the art will realize that, although block 104 indicates a “polling” approach for determining whether an incoming message is indicated, various other methods may be utilized to achieve similar functionality. For example, for at least one embodiment an incoming message may cause an asynchronous event. The asynchronous event may trigger a handler routine. For such embodiment, the remaining blocks (106, 108, 112, 116, 118, 120) of FIG. 1 may be performed by the handler routine.

If an incoming message is indicated at block 104 (or is indicated by an asynchronous event such as an exception or interrupt), then it is determined at block 106 whether the wireless device is currently in a special silent mode that permits caller override. If not, then processing proceeds to block 108, where the incoming message is processed normally.

One or more priority levels of the special mode may be implemented for each embodiment of the present invention. For multiple-mode embodiments, the multiple special silent modes are each evaluated at block 106, to determine if the wireless device has been placed into any of the special modes. If a special silent mode is detected at block 106, then processing proceeds to block 110.

For example, the user of the wireless device may select one or more of a low-, medium- or high-level special silent mode at a given time. For the low-level special silent mode, the user may give a larger group of persons the key value corresponding to override privileges for that mode. The user may place the wireless communication device into a low-level special silent mode, for example, when the user's desire for silence is relatively low. A relatively large number of persons may therefore enjoy override privileges for such mode.

A smaller group, or different group, of persons may be given a second key value, corresponding to the medium-level special silent mode. Finally, only a select one or few persons may be given the high-level priority override key. Depending on how the user has distributed knowledge of the key values, some persons may enjoy only low- and/or medium-level override privileges, while one or more persons may enjoy all three levels of priority. Alternatively, certain callers, such as key clients or those needing an emergency contact number, may be given only the high-priority override key value. Of course, the foregoing example should not be taken to limit a multi-mode embodiment to three special silent modes. Any number of special silent modes may be implemented.

At block 110 it is determined whether the originator of the incoming message is designated in the group of originators having override privileges for the current special silent mode. For at least one embodiment, the processing of block 110 assumes that the wireless device that is performing the method 100 supports some manner of identifying the originator of the incoming message. For at least one embodiment, such manner of identification is a technology known as caller id. However, one of skill in the art will realize that any manner of identifying the originator of an incoming message may be utilized. For example, for at least one embodiment an originating caller may associate a short message (also referred to as a text message) via a short message service (SMS) with an incoming call, where the short message contains an identifier to specify the identity of the originator of the incoming message.

If it is determined at block 110 that the originator of the message is within the selected group of originators that enjoy override privileges for the current special silent mode, then processing proceeds to block 112. Otherwise, the originator does not have override privileges for the current mode, and processing thus proceeds to block 108, where the message is processed normally. For special silent mode, normal processing at block 108 entails silent notification (for example, through blinking light, vibration, silent display, or no notification at all) of an incoming message. For a wireless device that provides telephony services, such as a cellular telephone, PCS system, or 3G wireless devices, an incoming call may be routed, at block 108, to voicemail if the user does not answer an incoming silent call. For such wireless devices that also support SMS and/or email, and for other devices, (such as pagers and BLACKBERRY wireless devices), that only support email or SMS messaging, an incoming text message or email may be saved, at block 108, in a message bank if the user does not take action to receive, read, delete, or respond to a silent incoming text message.

If the originator is determined to be in the selected override group at block 110, then processing proceeds to block 112. At block 112, an originator within the override group is given an opportunity to indicate whether the current incoming call should be treated as “urgent” and thus be permitted to override the silent mode. For at least one embodiment, the originator may indicate the priority of the message at block 112 via spoken response to pre-recorded prompts. For at least one other embodiment, the originator may indicate the priority of the message via entry of textual information on the originator's device keypad, touchpad, computer keyboard or the like. For at least one other embodiment, both spoken and text options are provided to the user at block 112.

One of skill in the art will recognize that block 112 is optional. That is, certain embodiments of the method 100 may permit messages originating from any member of the override group to automatically override the special silent mode. In such case, the prompt 112 is not performed.

After the originator has indicated call priority at block 112, processing proceeds to block 116 to determine whether the priority of the incoming message is such that it should override the special silent mode and should be indicated audibly. For embodiments in which override is automatically permitted and block 112 is thus not present, then the evaluation at block 116 will always evaluate to “true”, or alternatively is not performed at all. Broken lines in FIG. 1 denote the optional nature of blocks 112 and 116.

If the evaluation at block 116 evaluates to “true,” then processing proceeds to block 118. Otherwise, the originator has indicated that the incoming message is not urgent, and processing thus proceeds to block 108, where the incoming message is processed normally. Processing then ends at block 120.

At block 118, the incoming message is treated as a high priority message, and processing is performed to indicate the incoming message on the wireless device of the user. For at least one embodiment, the override message notification generated at block 118 is audible, such as a buzz or ring tone. For at least one other embodiment, the override message indicator generated at block 118 is inaudible. For example, for an embodiment that does not indicate incoming messages at all for a given special silent mode, the override indicator generated at block 118 may be inaudible, such as a blinking light, vibration, backlighting, secondary device message generation, or the like. Processing then ends at block 120.

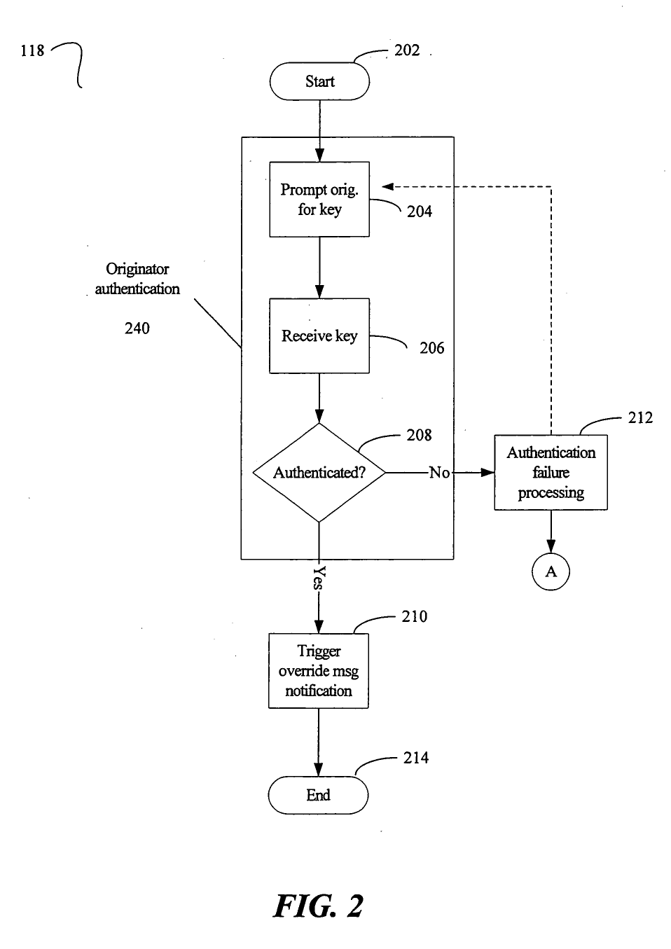

FIG. 2 is a flowchart illustrating additional details for at least one embodiment of the high-priority processing of block 118 of FIG. 1. Like the method 100 discussed above in connection with FIG. 1, at least one embodiment of the processing 118 is performed by a wireless communication device.

FIG. 2 illustrates that the high-priority processing 118 begins at block 202 and proceeds to block 204. At block 204, originator authentication 240 begins. It should be noted that the originator authentication of block 240 could be performed at an alternative point in the sequence of blocks discussed in FIGS. 1 and 2. For instance, for at least one alternative embodiment the authentication 240 may be performed between blocks 110 and 112 of FIG. 1.

At block 204, the originator of the incoming message is prompted for a key value. For at least one embodiment, the key value may be an alphanumeric or numeric value that may be input by the originator via a touchpad, touch screen, keypad or other input mechanism of the originator's communication device. For such embodiment, the user's wireless device may include one or more circuits that enable the device to recognize the tones entered by the originator, and to associate the tones with a particular alphanumeric or numeric value. Alternatively, the key may be spoken by the originator, and may be received and decoded by a voice recognition module in the user's wireless device.

For either the spoken or textual entry approach for the key value, a key value entered by an originator may be received and decoded by a voice recognition module or tone recognition module (respectively) on a non-mobile device, such as a switching station, and the decoded key may then be communicated to the user's wireless device from the switching station.

Thus, at block 206 the key value is received by the user's wireless device. Processing then proceeds to block 208. At block 208 authentication of the key is performed, in order to determine whether the key value provided by the originator matches the key value that the user has previously set. If so, then processing proceeds to block 210.

If the key provided by the originator does not meet authentication requirements evaluated at block 208, then processing proceeds to block 212. At block 212 authentication failure processing occurs. At block 212, the originator may be prompted to re-enter the key value. For such embodiment, processing proceeds from block 212 back to block 204. The optional nature of such re-prompt is denoted with broken lines in FIG. 2. For an embodiment that provides for one or more re-prompts, the processing at block 212 may determine how many times the originator has provided, for the current incoming message, a key that has failed to authenticate. After a certain number of failures (such as three, for example) the optional re-prompt processing cease to be performed. Instead, processing may proceed directly to block 108 of FIG. 1. Of course, for at least one alternative embodiment, processing may proceed directly to block 108 from block 112, without any iterations of the optional re-prompt processing denoted by the broken line in FIG. 2.

As is stated above, if it is determined at block 208 that the key value entered by the user meets authentication requirements, then processing proceeds to block 210. At block 210, an override message indicator is initiated. For at least one embodiment, a ring tone is triggered on the user's wireless device at block 210, such that the current special silent mode is overridden with an audible message notification for the incoming message. Such action constitutes an “override” at least in the sense that an audible notification is generated for the wireless device, which remains in the special silent mode, and future messages will be indicated silently (unless they, too, are authorized for override processing), until the user causes the device to transition out of a silent mode. From block 210, processing ends at block 214.

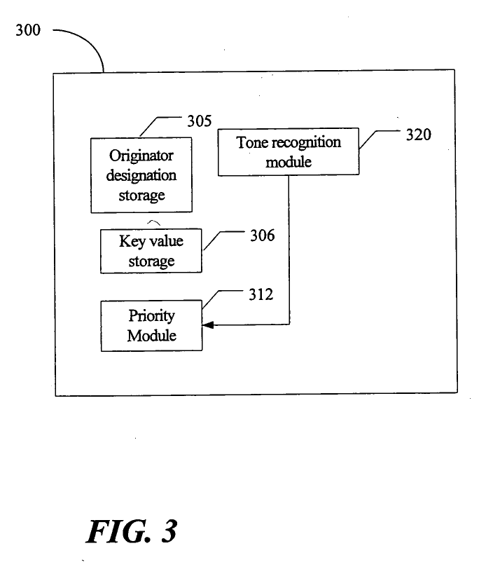

FIG. 3 is a block diagram illustrating at least one embodiment of a priority override module 300. The module 300 may reside in a wireless communication device. The module 300 may include components to facilitate performance of embodiments of the methods 100, 118 discussed above in connection with FIGS. 1 and 2.

The priority override module 300 is logic that may include one or more of the following elements: one or more integrated circuits (which may include application-specific integrated circuits (“ASIC”)), memory, and/or other hardware elements. The module 300 may also include software logic and/or firmware logic. One of skill in the art will understand that a module that performs the functionality of embodiments of the priority override module 300 discussed herein may include any or all of the aforementioned hardware, software, and firmware logic, or may include any combination thereof (including combinations that do not include one or more of the listed elements).

The embodiment of the priority override module 300 illustrated in FIG. 3 may include memory storage 306 for one or more key values and may also include memory storage 305 to hold identifiers for each originator that has been selected by the user to enjoy override privileges. For an embodiment that employs a plurality of special modes, the memory storage 305 may hold a value, such as multi-bit mask, to indicate which modes the originator is selected for. Of course, any other type of data structure, including tables, linked lists, objects, and the like, may be utilized to organize the data stored in the storage areas 305, 306. For at least one embodiment, the storage areas 305, 306, reside in writable non-volatile memory of a wireless device.

The memory storage 305, 306 may be provided by a DRAM, SRAM, Flash or other memory device. The key values may represent numeric or alphanumeric “codes” entered by the user of the communication device. (It is anticipated that the user will communicate the key values to certain selected individuals, so that those individuals may utilize the key value(s) to initiate high-priority message notification).

FIG. 3 also illustrates that the priority override module 300 may include a tone recognition module 330. The tone recognition module 330 is capable of interpreting tones entered by an originator on a touchpad, keypad, touch screen or other input mechanism. The tone recognition module 330 interprets such tones into alphanumeric or numeric values, and provides the values to a priority module 312. The tone recognition module 330 may be a hardware component, such as an integrated circuit.

The priority module 312 may interpret the values as a key, and may perform authentication to determine whether the originator has entered a valid key value, as compared with the one or more key values stored in the key value storage 306. For at least one embodiment, the priority module 312 may be a software module stored in a memory. However, for other embodiments, the priority module may be software, hardware, firmware, or any combination thereof.

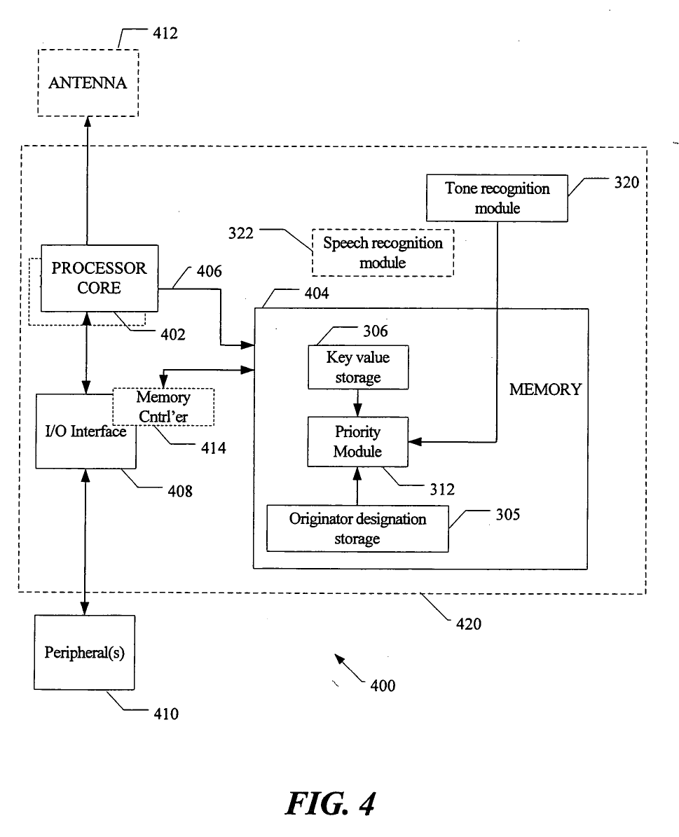

FIG. 4 is a block diagram illustrating at least one embodiment of at least a portion of a computing system 400 that may include a priority override module, such as (for example) the priority override module 300 illustrated in FIG. 3. Computing system 400 is intended to represent any number of computing and communication systems, including, but not limited to, mainframes, minicomputers, servers, workstations, personal computers, notepads, personal digital assistants, and various wireless communication devices that may include one or more optional antenna(e) 412 and/or embedded systems, just to name a few.

FIG. 4 illustrates that a processing system 400 may include various components including a processor core 402, a memory system 404, and at least one peripheral interface 408 to provide input/output (“I/O”) control functions for at least one peripheral device 410. The system 400 illustrated in FIG. 4 may be an embodiment of a system-on-a-chip (“SOC”), wherein various components 402, 404, 408 of a computing system, which perform separate tasks, are integrated into a single chip package 420.

One of skill in the art will recognize, of course, that components of processing system 400 need not necessarily be incorporated into a single chip package 420 in order to comport with the scope of the appended claims. Embodiments of the invention disclosed herein may be incorporated into SOC systems and/or multi-chip systems. Accordingly, the single chip package 420 illustrated in FIG. 4 is an optional feature.

One of skill in the art will also recognize that the sample embodiment 400 illustrated in FIG. 4 is merely one illustrative example of an SOC embodiment. Many other components, such as one or more additional processing core(s), additional memory (flash, RAM and/or ROM), universal asynchronous receiver-transmitters (“UARTs”), parallel ports, DMA (direct memory access) controllers, accelerators, modems, etc. may be included in an SOC chip without departing from embodiments of the present invention.

The components of a processing system 400 may be laid out in a planar fashion (as shown), may be stacked, or may be organized as any combination of layout approaches. For a multi-core embodiment, each processor core 402 need not be symmetric, in terms of size, power, functionality, etc., with the other cores 402 of the system 400. The optional nature of additional processor cores 402 in system 400 is denoted in FIG. 4 by broken lines for optional processor core(s).

FIG. 4 illustrates that the processor core(s) 402 may issue commands and data to memory system 404 over communication pathway 406. Communication pathway 406, as well as any other communication pathways of embodiments of the system 400 illustrated in FIG. 4, may be a multi-drop bus. Alternatively, communication pathway 406, and any other communication pathways of the embodiment 400 illustrated in FIG. 4 may be a point-to-point interconnect. Any combination of multi-drop buses and point-to-point interconnects may be utilized in embodiments of the system 400.

The memory system 404 may be associated with an integrated memory controller residing in the chip package 420, or may be accessed via a separate, non-integrated memory controller that does not reside on the chip package 420. For at least one embodiment, a single module (such as a chipset or memory-I/O hub) may provide memory controller functionality as well as providing the I/O interface 408. The dotted lines and placement for memory controller 414 illustrated in FIG. 4 indicate that the memory controller 414 may be integrated with the I/O interface module 408, or may be separate from the I/O interface module 408. In the case that the memory controller 414 is separate from the I/O interface module 408, it may be integrated into the core 402, may be integrated into the memory system 404, may be a non-integrated memory controller that resides outside the chip package 420, or may be integrated into the chip package 420 as shown in FIG. 4.

Memory system 404 may include, for example, FLASH memory, EEPROM, EPROM, ROM, ferromagnetic digital memory, phase-change memory, polymer memory, RAM, DRAM, SRAM, and/or the like. As is discussed above, FIG. 4 illustrates that memory system 404 may include storage 306 for one or more key values and storage 305 for one or more originator identifiers. A user of the computing system 400 may provide the values that are stored in such storage 305, 306.

For at least one embodiment, the key value(s) may be entered by the user on a peripheral device 401, such as a touchpad, keyboard, or touch screen. Alternatively, the key values may be entered audibly by voice. For any of the entry methods, such entry may be made at a convenient time for the user. For at least one embodiment, such value entry is an initialization procedure that need not be repeated until the user wishes to change one or more of the key values.

The user may define, and the key value storage 406 may provide storage capacity for, a single key value to be used by all originators designated by the user as having override privileges. Alternatively, the user may define separate key values for distinct originators or groups of originators for a single silent mode. For multi-mode embodiments, the user may define separate key values for each special silent mode, and may also, for at least one embodiment, define separate key values for distinct originators or groups of originators within one of the multiple modes.

In addition to the key value storage 406, FIG. 4 illustrates that the system 400 may also include a storage area 405 to store identifiers for designees whom the user wishes to grant override privileges.

FIG. 4 illustrates that the system 400 may also include a priority module 412. Such priority module 412 may include logic for performing a method to allow an originator of a message to override a user's selected message notification priority mode, such as the embodiments 100, 118 disclosed above in connection with FIGS. 1 and 2.

In FIG. 4, the priority module 412 is shown as being stored in the memory system 404. As such, the module 412 represents machine-accessible signals, such as software instructions, that, when executed by a processor core 402, cause the processor core 402 to perform an embodiment of the message priority method discussed above in connection with FIGS. 1 and 2. However, one of skill in the art will recognize that such module 412 need not exist as software instructions in the memory system 404. For at least one embodiment, for example, the module 412 may be a hardware module. Alternatively, the functionality of the method 100 may be performed partly in hardware and partly in software, may be performed as firmware instructions, such as those associated with microcode ROM, or may be exist as any combination of such approaches.

FIG. 4 further illustrates that the system 400 may also include a tone recognition module to recognize and decode tones entered by the originator in response, for example, to prompts at block 112 of FIG. 1 and/or block 204 of FIG. 2. For purposes of tone recognition for speech responses to such prompts, the system 400 may also include one or more optional speech recognition module(s) 322.

Sample system 400 is representative of processing systems based on Intel XScale® core, Intel® Micro Signal Architecture (Intel® MSA), Intel® PCA Cellular Processors, and/or Pentium®, Pentium® Pro, Pentium® II, Pentium® III, Pentium® 4, and Itanium® and Itanium® 2 microprocessors available from Intel Corporation, although other systems (including personal computers (PCs), cellular telephones, walkie-talkies, personal digital assistants and other hand-held devices having other microprocessors, engineering workstations, set-top boxes and the like) may also be used.

FIG. 5 is a data flow diagram illustrating at least one embodiment of a method 500 and data flow for initializing a communication device for a special silent mode that provides a user override mechanism. As is mentioned above, such initialization need be performed only when a user wishes to add/change the key value(s) and/or originator identifier(s) associated with a particular special silent mode. The initialization 500 may thus be performed, for at least one embodiment, by a user of a communication device.

FIG. 5 illustrates the processing for the initialization 500 begins at block 502 and proceeds to block 504. At block 504, the user enters a key value for the desired special silent mode. The key value is stored 505 in the key value storage 306 in the memory system (see, for example, memory system 404 of FIG. 4). FIG. 5 illustrates, with a broken line, that the processing 504, 505 may optionally be repeated for additional special silent modes and/or for additional key values within a given mode (to be used, for example, by a selected sub-class of originators for the given mode). Processing then proceeds to block 506.

At block 506, the user enters an originator identifier for each originator to have privileges for each of one or more special silent modes. The identifier(s) are stored 507 in the originator identifier storage 305 of the memory system. Multiple originator identifiers may be entered 506 for each special silent mode. A single originator may be authorized to have override privileges for multiple of the special silent modes, in multi-mode embodiments.

Processing for the initialization method 500 may end after execution of block 506. Such feature is designated by a dotted line between blocks 506 and 512 in FIG. 5. At a later time, the user may activate the special silent mode (single-mode embodiment) or one of the special silent modes (multi-mode embodiment) for which key values and originator identifiers have been set up at blocks 504 and 506.

Alternatively, the user may proceed from block 506 to block 508 in order to select one of the special silent modes immediately after initializing key values and originator identifiers. At block 508, the user selects and activates a special silent mode such that the communications device is placed into a silent message notification mode that may be overridden by the designated originators for the mode.

At some point, it is assumed that the user will communicate the key value for the mode to the designated originators. The timing for such notification is flexible. Accordingly, the notification 510 is denoted in FIG. 5 with a broken line, to indicate the flexible nature of the timing for performance of such action. Processing then ends at block 512.

A method is here, and generally, considered to be a self-consistent sequence of acts or operations leading to a desired result. One skilled in the art will recognize that the blocks representing the sequence of operations illustrated in FIGS. 1, 2 and 5 may include one or more logical functions that may be performed individually or concurrently, rather than as a single logical block. Similarly, the functions illustrated in distinct blocks in FIGS. 1, 2 and 5 may be combined and performed by a single procedure or function. One of skill in the art will recognize that the operations of a method need not necessarily be performed in the order illustrated, as long as the re-ordered sequence preserves the desired functionality of the method. In particular, it will be appreciated that blocks 504, 506 and 510 of FIG. 5 may be performed in any order with respect to each other.

The sequence of actions or operations of the disclosed method embodiments 100, 118, 500 include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as values, indicators, identifiers, elements, numbers or the like. It should be understood, however, that all of these and similar terms are to be associated with the appropriate physical quantities and are merely convenient labels applied to these quantities.

The foregoing discussion describes selected embodiments of methods, systems and apparatuses relating to a message priority mechanism that provides override capability to certain pre-selected message originators. In the preceding description, various aspects of methods, system and apparatuses have been described. For purposes of explanation, specific numbers, examples, systems and configurations were set forth in order to provide a more thorough understanding. However, it is apparent to one skilled in the art that the described method and apparatus may be practiced without the specific discussed details.

It should be understood that embodiments of the present invention may be used in a variety of applications. Although the present invention is not limited in this respect, the circuits disclosed herein may be used in many apparatuses such as in the transmitters and receivers of a radio system. Radio systems intended to be included within the scope of the present invention include, by way of example only, wireless local area networks (WLAN) devices and wireless wide area network (WWAN) devices including wireless network interface devices and network interface cards (NICs), base stations, access points (APs), gateways, bridges, hubs, cellular radiotelephone communication systems, satellite communication systems, two-way radio communication systems, one-way pagers, two-way pagers, walkie-talkies, personal communication systems (PCS), personal computers (PCs), personal digital assistants (PDAs), and the like, although the scope of the invention is not limited in this respect.

Types of wireless communication systems intended to be within the scope of the appended claims include, although not limited to, Wireless Local Area Network (WLAN), Wireless Wide Area Network (WWAN), Code Division Multiple Access (CDMA) cellular radiotelephone communication systems, Global System for Mobile Communications (GSM) cellular radiotelephone systems, North American Digital Cellular (NADC) cellular radiotelephone systems, Time Division Multiple Access (TDMA) systems, Extended-TDMA (E-TDMA) cellular radiotelephone systems, third generation (3G) systems like Wide-band CDMA (WCDMA), CDMA-2000, and the like, although the scope of the claims is not limited in this respect.

A wireless device or interface may be understood to mean any one of a variety of devices or interfaces for wireless communications. Examples include but are not limited to any combination of devices for one or more of the following: short-range radio, satellite communications, wireless local area networks, wireless telephony, cellular digital packet data, home radio frequency, narrowband time-division multiple access, code-division multiple access, wideband code-division multiple access, wireless fidelity or short message service.

Embodiments of the methods described herein may be implemented in hardware, hardware emulation software or other software, firmware, or a combination of such implementation approaches. Embodiments of the invention may be implemented for a programmable system comprising at least one processor, a data storage system (including volatile and non-volatile memory and/or storage elements), at least one input device, and at least one output device. For purposes of this application, a processing system includes any system that has a processor core. The processor core may be any type of processing element including, for example, a digital signal processor (DSP), a microcontroller, an application specific integrated circuit (ASIC), or a general purpose microprocessor.

Embodiments of the invention may also be implemented as instructions stored on a machine-accessible medium, or as machine-accessible electrical, optical, acoustical or other form of propagated signals (e.g., carrier waves, infrared signals, digital signals, the interfaces that transmit and/or receive signals, etc.) which may be read and executed by a processing system to perform the operations described herein. A machine-accessible medium may include any mechanism for storing or transmitting information in a form readable by a machine (e.g., a computer). A program may be stored on a storage media or device (e.g., magnetic storage medium, hard disk drive, floppy disk drive, read only memory (ROM), random access memory (RAM), CD-ROM device, flash memory device, digital video disk (DVD), optical storage device, or other storage device), readable by a general or special purpose programmable processing system.

The instructions, accessible to a processor in a processing system, provide for configuring and operating the processing system when the storage media or device is read by the processing system to perform the procedures described herein. Embodiments of the invention may also be considered to be implemented as a machine-readable storage medium, configured for use with a processing system, where the storage medium so configured causes the processing system to operate in a specific and predefined manner to perform the functions described herein.

Accordingly, one of skill in the art will recognize that changes and modifications can be made without departing from the present invention in its broader aspects. The appended claims are to encompass within their scope all such changes and modifications that fall within the true scope of the present invention.

What is claimed is:

1. An apparatus, comprising:
a first memory storage to store one or more key values;
a second memory storage to store one or more entity identifiers;
a priority module, coupled to the first and second storage, to provide for override of a silent message notification mode for a wireless communication device, based on input from a remote entity.

2. The apparatus of claim 1, further comprising:
a tone recognition module, coupled to the priority module, the tone recognition module to receive and interpret tones generated by the remote entity.

3. A system comprising:
an antenna;
a processor core; and
priority logic to provide a priority message notification for a wireless communication device that is in a silent mode, the priority logic to provide the priority message notification only if input from a remote entity is authenticated.

4. The system of claim 3, further comprising:
a memory storage, coupled to the priority logic, to store one or more key values.

5. The system of claim 4, wherein:
said priority logic is to utilize one or more stored key values from said memory storage in order to authenticate said input.

6. The system of claim 3, further comprising:
a memory storage, coupled to the priority logic, to store one or more originator identifiers.

7. The system of claim 6, wherein:
said priority logic is to utilize one or more originator identifiers from said memory storage in order to authenticate said input.

8. The system of claim 3, further comprising:
a memory system;
wherein said priority logic is stored in said memory system.

9. A method comprising:
entering a silent mode of a wireless communication device;
detecting an incoming message from a remote entity;
determining whether the remote entity is a member of a designated class;
if so, based on input from the remote entity, generating a priority message notification.

10. The method of claim 9, further comprising:
authenticating user override privileges for the remote entity.

11. The method of claim 10, further comprising:
receiving a key value and storing the key value in memory associated with the wireless communication device.

12. The method of claim 11, wherein said authenticating further comprises:
comparing the stored key value with a key value received from the remote user.

13. The method of claim 9, further comprising:
receiving an identifier associated with each of one or members of the designated class and storing the identifier in the memory.

14. The method of claim 13, wherein said determining whether the remote entity is a member of a designated class is based on the one or more stored identifiers.

15. The method of claim 9, wherein said input from the remote entity is a numeric key value.

16. The method of claim 9, wherein said input from the remote entity is received as a tone.

17. The method of claim 9, wherein said input from the remote entity is received as speech.

18. A machine-accessible medium having a plurality of machine accessible instructions, wherein, when the instructions are executed by a processor, the instructions provide for:
entering a silent mode of a wireless communication device;
detecting an incoming message from a remote entity;
determining whether the remote entity is a member of a designated class;
if so, based on input from the remote entity, generating a priority message notification.

19. The machine-accessible medium as recited in claim 18, further comprising instructions that, when the instructions are executed by a processor, the instructions provide for:
authenticating user override privileges for the remote entity.

20. The machine-accessible medium of claim 18, further comprising instructions that, when the instructions are executed by a processor, the instructions provide for:
receiving a key value and storing the key value in memory storage associated with the wireless communication device.

21. The machine-accessible medium of claim 20, wherein said instructions that, when executed, provide for said authenticating further comprise instructions that provide for:
comparing the stored key value with a key value received from the remote user.

22. The machine-accessible medium of claim 18, further comprising instructions that, when the instructions are executed by a processor, the instructions provide for:
receiving an identifier associated with each of one or members of the designated class and storing the identifier in the memory.

23. The machine-accessible medium of claim 22, wherein said instructions that, when executed, provide for determining whether the remote entity is a member of a designated class further comprise instructions that, when executed, provide for basing said determining on the one or more stored identifiers.

24. The machine-accessible medium of claim 18, further comprising instructions that, when executed by a processor, provide for receiving said input from the remote entity, wherein said input is a numeric key value.

25. The machine-accessible medium of claim 18, further comprising instructions that, when executed by a processor, provide for receiving said input from the remote entity, wherein said input is a tone.

26. The machine-accessible medium of claim 18, further comprising instructions that, when executed by a processor, provide for receiving said input from the remote entity as speech.

27. The system of claim 3, wherein the priority message notification is audible.

28. The method of claim 10, wherein the priority message notification is audible.

29. The machine-accessible medium of claim 18, wherein the priority message notification is audible.
